(19) United States
(12) Patent Application Publication
(10) Pub. No.: US 2007/0247058 A1
(43) Pub. Date: Oct. 25, 2007

(54) Self-luminous display device

(76) Inventors: Yuichi Inoue, Mobara (JP); Yoshiro Mikami, Hitachioota (JP); Shigemi Hirasawa, Chiba (JP); Yoshie Kodera, Chigasaki (JP); Nobutake Konishi, Mobara (JP)

Correspondence Address: MILBANK, TWEED, HADLEY & MCCLOY, 1 CHASE MANHATTAN PLAZA, NEW YORK, NY, 10005-1413, US

(21) Appl. No.: 11/788,294

(22) Filed: Apr. 19, 2007

(30) Foreign Application Priority Data
Apr. 21, 2006 (JP) 2006-117830

(51) Int. Cl. H01J 31/12

(52) U.S. Cl. 313/496

(57) ABSTRACT

The present invention suppresses color irregularities or a black spot defect by reducing mislanding of electron beams or the generation of discharge at end portions of a spacer. The spacer is arranged on scanning lines as a single member having no split portions, and the spacer has both end portions thereof positioned exceeding both sides of a display region in the lateral direction (x direction) formed of a two-dimensional arrangement of electron sources and phosphors. An anode is formed to cover a display region with a width exceeding a width of the display region in the extending direction of the scanning lines. Both end portions of the spacer in the lateral direction (x direction) are arranged at positions retracted from a width of the anode. In the lateral direction, a relationship of the width of the display region<the width of the spacer<the width of the anode is established. The phosphors are applied to stripe-like black matrix apertures which extend in the vertical direction (y direction).

### CLAIM OF PRIORITY

The present application claims priority from Japanese Application JP 2006-117830 filed on Apr. 21, 2006, the content of which is hereby incorporated by reference into this application.

### BACKGROUND OF THE INVENTION

1. Field of the Invention

The present invention relates to a self-luminous display device, and more preferably applicable to a flat-panel-type display device using thin film electron sources.

2. Description of the Related Art

As one of flat-panel-type display devices using thin film electron sources, there has been known a display device which uses MIM-type electron emission elements as electron sources. FIG. 5 is a perspective view with a part broken away showing the inside of a constitutional example of a display device (hereinafter, also referred to as “panel”) which uses MIM-type electron emission elements as electron sources thereof. Further, FIG. 6 is a cross-sectional view taken along a line A-A′ in FIG. 5. The panel is integrally formed of a back panel PNL1 which forms the electron source structure on an inner surface of a back substrate SUB1, a face panel PNL2 which forms a phosphor screen which emits light upon excitation of electrons on an inner surface of a face substrate SUB2, and a sealing frame MFL which is interposed between opposing peripheries of the back panel PNL1 and the face panel PNL2 and forms a hermetically sealed space in a region where the back panel PNL1 and the face panel PNL2 face each other with a distance therebetween restricted by spacers SPC.

In the back panel PNL1, a plurality of data lines dL and a plurality of scanning lines sL which intersect the data lines dL by way of an insulation layer are mounted on the back substrate SUB1 which is preferably made of glass. Electron sources are formed on the data lines dL in the vicinity of scanning lines sL. In the face panel PNL2, a phosphor screen is formed, on the face substrate SUB2 which is preferably made of transparent glass wherein the phosphor screen is constituted of a plurality of phosphors PH which are applied to apertures formed in a light blocking film (black matrix) BM (BM aperture) and an anode (metal back) AD. Electrons which are emitted from the electron sources are accelerated by an acceleration voltage applied to the anode AD and impinge on the phosphors as electron beams and excite the phosphors to emit light.

The sealing frame MFL which is interposed between the opposing peripheries of the back panel PNL1 and the face panel PNL2 is often made of glass. Further, in such constitution, the spacers SPC are mounted on each scanning line sL in a three-split state. These respective structural parts are adhered to each other using frit glass. End portions of the data lines dL are pulled out to the outside of the sealing frame MFL as data-line lead terminals dT and end portions of the scanning lines sL are pulled out to the outside of the sealing frame MFL as scanning-line lead terminals sT. A pressure inside the hermetically sealed space is reduced to a predetermined degree of vacuum by an exhaust pipe EXC. Here, this type of display device is disclosed in JP-A-2004-363075.

With respect to the display device using the MIM-type electron emission elements as electron sources, in the pixel positioned in the vicinity of the spacer, an electron beam is displaced and is deviated from a predetermined phosphor due to a deflection action attributed to charging of the spacer thus generating mislanding of the electron beam which leads to the lowering of brightness. This lowering of brightness brings about an image defect. Heretofore, to cope with such drawbacks, the resistance to the spacer is adjusted or coating is applied to the surface of the spacer. However, under a condition that the charged charge is to be eliminated completely, the resistance of the spacer is lowered and the power consumption of the spacer is increased and hence, it is difficult to completely remove the image defect by only lowering the resistance. Further, the mislanding of the electron beam attributed to the charged charge makes the trajectory of the electron beam changed in the lateral direction (left-and-right direction) in both ends of the spacer in the longitudinal direction (both ends or left and right ends in the scanning-line extending direction) and hence, mixing of other color occurs.

As the spacer constitution, since the spacers can be manufactured easily and the miniaturized display device can be easily manufactured conventionally, approximately 2 to 10 spacers are arranged in parallel for one scanning line of the display device. On the other hand, in Japanese Patent 3305166, there is described the spacer constitution having the specification in which the assembling man-hours is simplified by replacing the spacers with one elongated spacer extending in the lateral direction thus reducing the number of parts leading to the low cost.

In the constitution described in Japanese Patent 3305166, one elongated semiconductive spacer is arranged on the scanning line, and the spacer, a face substrate (referred to as anode substrate) and the scanning line are electrically brought into contact with each other. By controlling the surface resistance of the semiconductive spacer to 10⁵ to 10¹²Ω/□, the deviation (deflection) of trajectory of an electron beam can be prevented.

Japanese Patent 3305166 only describes that spacer is arranged above the scanning line with respect to a place where the spacer is arranged. However, when inventors of the present invention have investigated the deviation of trajectory of the electron beam in detail, it is found that the electron beam is deviated in the x direction at an end portion of the spacer. FIG. 7 is an explanatory view of spacers and pixels in which electron beams are deviated. In FIG. 7, symbol BS indicates electron beam spots, symbol ELSCX indicates an x-direction aperture center of electron sources (cathodes), symbol ELSCY indicates a y-direction aperture center of electron sources, symbol PY indicates a pixel in which the electron beams are deviated in the y direction, and symbol PXY indicates pixels in which the electron beams are deviated in the xy direction.

As shown in FIG. 7, in the pixels which are positioned in the vicinity of portions of the spacer SPC except for the end portions of the spacer SPC, the electron beams are deviated in the y direction. On the other hand, in the pixel which is positioned in the vicinity of an end portion of the spacer SPC, the electron beams are also deviated in the x direction. That is, in the pixel positioned in the vicinity of the end portion of the spacer SPC, the electron beams are deviated in the xy directions.

Japanese Patent 3305166 describes only the deviations of portions above and below the spacer (in the longitudinal direction or in the y direction). However, in the display device which repeatedly arranges sub pixels of R, G and B, a pitch in the left-and-right direction (lateral direction, x direction) is only ⅓ of a pitch in the longitudinal direction. Accordingly, the deviation of electron beams in the x direction at lateral directional end portions of the spacer largely influences an image defect and hence, the deviation of the electron beams in the x direction is more important than the deviation of the electron beams in the y direction by the same amount. This is because that when the electron beams are deviated in the x direction, there may arise “mixing of other color” which is a display defect in which the electron beams are radiated to phosphors of the neighboring sub pixel and emits light of other color. That is, the deviation of the electron beams in the x direction brings about a display defect which remarkably lowers a display quality. In view of the above, the display device is required to eliminate the image defect attributed to the deviation of the electron beams in the lateral direction.

A display device which lowers the surface resistance of spacers is produced on trial bases and the deviation of electron beams is studied. Although the deviation of electron beams is reduced along with lowering of resistivity, the deviation of electron beams is still recognized with the resistivity of 5×10⁷Ω/□. Assuming that 20 pieces of spacers are arranged in a panel of nominal 32 size, an electric current which flows in the spacers is increased when the resistivity is 5×10 ⁷Ω/□. To make a trial calculation of power consumption of the spacer, it is found that the power consumption amounts to 46 W. When an excessively large current is made to flow into the spacers, there arises a drawback that the power consumption of a display device is increased. Further, when a large current flows in the spacer, the spacer is heated and may be broken due to a thermal stress. In this manner, there has been a demand for a technique which can eliminate the display defect attributed to the deviation of the electron beams even with the resistance value which falls within a range capable of preventing a large increase of the power consumption of the spacers. Further, end portions of the spacer exhibit high discharging frequency and hence, when the discharging is performed at the electron source of the pixel, a voltage which far exceeds a withstand voltage of the electron source is applied to the electron source thus deteriorating the MIM electron source element (cathode) and generating a black-spot defect whereby a lifetime of a panel is remarkably shortened.

### SUMMARY OF THE INVENTION

Accordingly, it is an object of the present invention to provide a self-luminous display device which can suppress color irregularities and black-spot defects by reducing the mislanding of electron beams and the generation of discharge at end portions of a spacer.

A self-luminous display device of the present invention is constituted of a back substrate which includes a plurality of data signal lines, a plurality of scanning lines which are arranged to intersect the data signal lines while being insulated from the data signal lines, and a plurality of electron sources which are arranged in the vicinity of intersecting portions of the data signal lines and the scanning lines, a face substrate which includes a phosphor screen formed of phosphors of a plurality of colors which constitute pairs with the respective electron sources of the back substrate and emit light by being excited by electrons taken out from the electron sources and an anode, the face substrate being arranged to face the back substrate in an opposed manner with a predetermined gap therebetween, a sealing frame which is inserted between opposing peripheries of the back substrate and the face substrate thus constituting a hermetically sealed space, and spacers which are arranged in an erected manner in a gap between opposing surfaces of the back substrate and the face substrate while holding the predetermined distance.

According to the present invention, to achieve the above-mentioned object, the spacer is arranged on the scanning line as a single member having no split portions, and the spacer has both end portions thereof positioned exceeding both sides of a display region formed of a two-dimensional arrangement of the electron sources and the phosphors.

Further, in the present invention, the anode may be formed to cover the display region with a width thereof exceeding a width of the display region in the extending direction of the scanning lines, and both end portions of the spacer may be arranged at positions retracted toward the inside (in the direction toward the display region) than the width of the anode.

Further, in the present invention, the phosphors may be applied to black matrix apertures which are formed in a stripe shape along the extending direction of the data signal lines, or the phosphors may be applied to the black matrix apertures formed in a stripe shape which are cut into sections in the extending direction of the data signal lines with the length corresponding to a deviation quantity of electron beams in the extending direction of the data signal lines attributed to a charged charge of the spacer along the extending direction of the data signal line.

According to the present invention, it is possible to acquire a self-luminous display device which hardly generates color irregularities or black-spot defects by reducing mislanding of electron beams or the generation of discharge at end portions of the spacer.

### BRIEF DESCRIPTION OF THE DRAWINGS

FIG. 1 is a plan view for explaining an embodiment 1 of a self-luminous display device according to the present invention;

FIG. 2 is a cross-sectional view of an essential part of a left end of the self-luminous display device in the x direction in FIG. 1;

FIG. 3 is a plan view of an essential part for explaining an embodiment 2 of a self-luminous display device according to the present invention;

FIG. 4 is a plan view of an essential part for explaining an embodiment 3 of a self-luminous display device according to the present invention;

FIG. 5 is a perspective view with a part broken away showing the inside of a constitutional example of a display device which uses MIM-type electron emission elements as electron sources;

FIG. 6 is a cross-sectional view taken along a line A-A′ in FIG. 5; and

FIG. 7 is an explanatory view of spacers and a pixel in which electron beams are deviated.

### DESCRIPTION OF THE PREFERRED EMBODIMENTS

Hereinafter, preferred embodiments of the present invention are explained in detail in conjunction with attached drawings.

### Embodiment 1

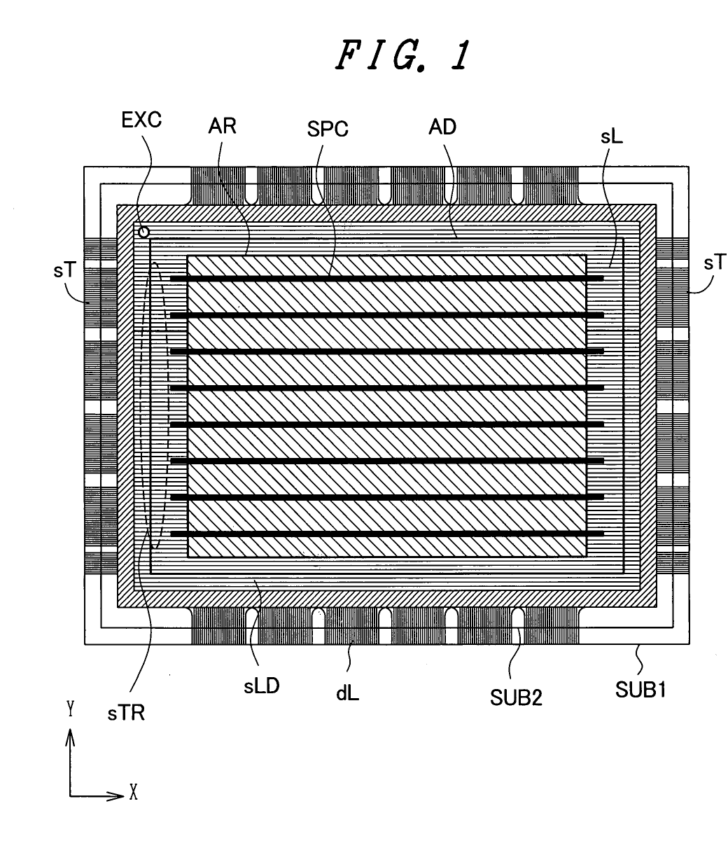

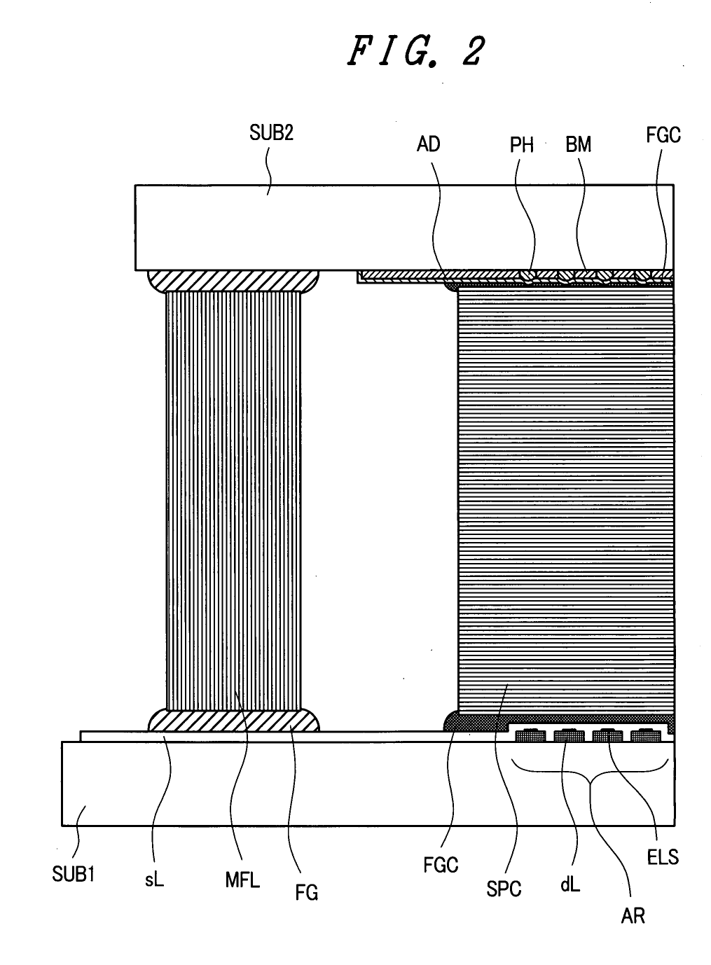

FIG. 1 is a plan view for explaining an embodiment 1 of a self-luminous display device according to the present invention. Further, FIG. 2 is a cross-sectional view of an essential part of a left end of the self-luminous display device in the x direction in FIG. 1. In the self-luminous display device, on scanning lines sL which extend in the lateral direction (x direction) on a back substrate SUB1, one spacer SPC is arranged. On a face substrate SUB2, phosphors PH are applied to apertures of a black matrix BM formed in a stripe shape in the vertical direction (y direction).

In this self-luminous display device, a plurality of pairs constituting of electron sources ELS formed on the back substrate SUB1 and phosphors PH formed on the face substrate SUB2 are arranged two dimensionally to form a display region AR. Here, scanning line lead regions sTR are formed on both left and right sides of the display region AR, while dummy scanning lines sLD are formed on both upper and lower sides of the display region AR.

As shown in the drawing, in the embodiment 1, the spacer SPC is arranged on the scanning lines sL as a single member having no split portions, and the spacer SPC has both end portions thereof positioned exceeding both sides of the display region AR which is formed by arranging the electron sources and the phosphors two-dimensionally in the lateral direction (x direction). Here, a sealing frame MFL is fixed to the back substrate SUB1 and the face substrate SUB2 by adhesion using frit glass FG. Further, the spacer SPC is fixed to the back substrate SUB1 and the face substrate SUB2 by adhesion using conductive frit glass FGC.

Further, an anode AD is formed to cover the display region with a width exceeding a width of the display region AR in the extending direction of the scanning lines sL. Both end portions of the spacer SPC in the lateral direction (x direction) are arranged at positions more retracted to the inside (in the direction of the display region) than a width of the anode AD. That is, in the lateral direction, a relationship of a width of the display region AR<a width of the spacer SPC<a width of an anode AD is established. Further, the phosphors are applied to the stripe-like black matrix apertures which extend in the vertical direction (y direction)

By setting a length of the spacer larger than a lateral width of the display region, the left and right end portions of the spacer are arranged outside the display region and hence, the left and right ends of the spacer are not present within the display region whereby bending of the electron beams in the x direction in the whole display region is not generated thus eliminating a display defect.

The data signal lines and the scanning lines are formed on the cathode substrate. The data signal lines are made of aluminum (Al) and the electron sources (MIM elements) are formed by anodizing (AO) surfaces of the data signal lines. A manufacturing process of the back substrate and the face substrate, panel assembling and an evacuation step are equal to corresponding manufacturing process, panel assembling and the evacuation step of a related art. The scanning lines sL in the display region AR are pulled out from the display region AR and are connected with left and right lead terminals sT by way of scanning-line lead regions sTR. With respect to the outside of the display region, in regions above and below the display region, the dummy scanning lines sLD are arranged using a layer of the scanning lines, the dummy scanning lines sLD are pulled out from left and right terminals, and a potential of arbitrarily low impedance such as a non-selected voltage of the scanning line, a power source of the scanning line or a ground potential is applied to the dummy scanning lines sLD. Due to such a constitution, charging of a surface of the back substrate in such a portion can be suppressed thus preventing discharging. Further, even when discharging occurs by a chance, the structure possesses a shielding effect which generates the discharge of the dummy scanning lines and prevents the discharge to the data signal line and hence, it is possible to prevent the electron sources from being broken via the data signal lines or it is possible to prevent the drive circuit of the data signal lines from being broken.

On the cathode substrate, one spacer is substantially uniformly arranged on the scanning lines. A length of the spacer is set larger than a lateral width of the display region. A width of the anode electrode in the lateral direction is set such that both ends of the anode electrode are arranged outside the display region, outside the lateral end portions of the spacer, and inside the frame glass. Due to such a constitution, end portions of the spacer can be arranged in the inside of a vertical electric field parallel to the anode substrate and the cathode substrate. Further, a height of the anode electrode in the longitudinal direction is set such that both ends of the anode electrode are arranged outside the display region and the inside the frame glass. Due to such a constitution, the outside of the display region can be arranged in the inside of the vertical electric field parallel to the anode substrate and the cathode substrate thus preventing the discharge to the pixel.

The frame glass is adhered to the cathode substrate and the anode substrate by way of frit glass thus holding a vacuum created in the inside of the panel. The spacer is adhered to the cathode substrate and the anode substrate using conductive frit which is formed by mixing frit glass and a conductive paste. Here, the spacer has a cathode substrate side thereof adhered to the scanning lines and an anode substrate side thereof adhered to a metal back surface made of aluminum (Al). Accordingly, the anode substrate, the cathode substrate and the spacer are connected with each other with conductivity.

The left end of the spacer is arranged on a side more left than the end of the display region in which the electron sources (MIM elements) are arranged. Further, left end portions of the metal back and the black matrix are arranged on a side more left than the spacer and on a side more right than the frame glass region. With respect to an electric field generated by a high voltage applied to the anode, a parallel electric field state between the substrates is maintained up to the outside of the display region and hence, the discharge is hardly generated. Further, even when the discharge is generated at the end portion of the spacer or the electrode end portion of the anode, the portion of the discharge is remote from the pixel and hence, the discharge is generated in the scanning line without being discharged in the electron sources whereby it is possible to acquire the highly reliable display device which can eliminate the rupture of the pixels.

That is, in the embodiment 1, by setting the length of the spacer SPC smaller than the lateral width of the anode electrode (AD), it is possible to arrange the end portions of the spacer SPC in the inside of the uniform electric field and hence, the discharge is hardly generated even at the end portions of the spacer. Further, even when the discharge is generated at the end portions of the spacer, the portions of the discharge are remote from the pixels and hence, there is no possibility that the pixels are broken by the discharge thus enhancing the reliability of the display device. Due to the constitution of the embodiment 1, it is possible to prevent mixing of other colors attributed to the deviation of the electron beams at the end portions of the spacer SPC.

### Embodiment 2

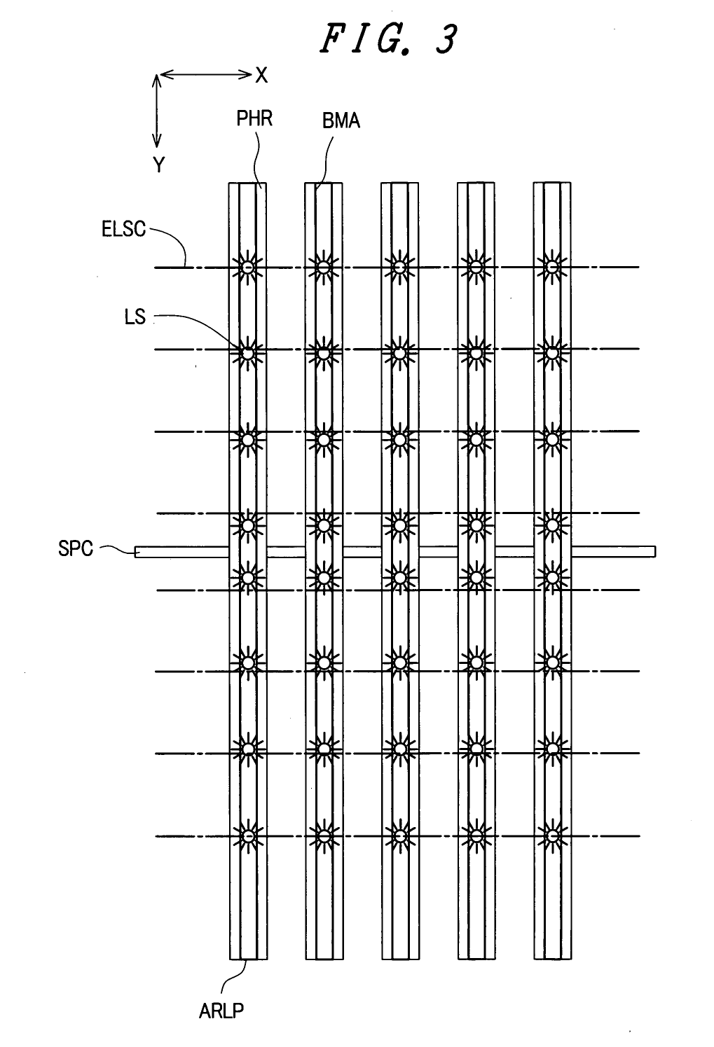

FIG. 3 is a plan view of an essential part for explaining an embodiment 2 of a self-luminous display device according to the present invention. The embodiment 2 is, in the spacer constitution of the embodiment 1, configured such that the phosphors formed on the face substrate are formed in a longitudinal stripe shape thus forming the black matrix into continuous longitudinally-elongated windows. A phosphor region PHR is formed by coating in a state that the phosphor region PHR covers a black matrix aperture BMA. In the drawing, symbol ELSC indicates the center of the aperture of an electron source (MIM element), symbol LS indicates a light emission spot, and symbol ARLP indicates a left-end pixel in the display region.

That is, the embodiment 2 adopts a pattern in which the vertical stripe constitution is adopted as the pixel constitution, and the phosphors are continuously arranged in the vertical direction and are repeatedly applied in order of R, G, B, R, G, B. The aperture portions of the black matrix to which the phosphors are applied constitute the longitudinally continuous windows. FIG. 3 shows a display state in which all pixels are turned on. In the drawing, symbol LS depicted by a circle indicates light emitting spots of the phosphors which are generated by the electron beams radiated from the aperture portions of the respective electron sources (MIM elements). Since the electron beams are deviated due to charging of the spacer, in the vicinity of the spacer SPC, the positions of the light emitting spots LS are shifted vertically from the center of the aperture portion of the electron source and are deviated to approach the spacer SPC. However, all electron beams arrive at the phosphors and emit light thus preventing a display defect.

In the constitution of the embodiment 2, the direction that the electron beams are deviated is only the y direction in all pixels, and the phosphors are continuously formed in the y direction and hence, even when the electron beams are deviated, the electron beams are radiated to the phosphors sufficiently where by there is no possibility that an image defect such as lowering of brightness occurs.

### Embodiment 3

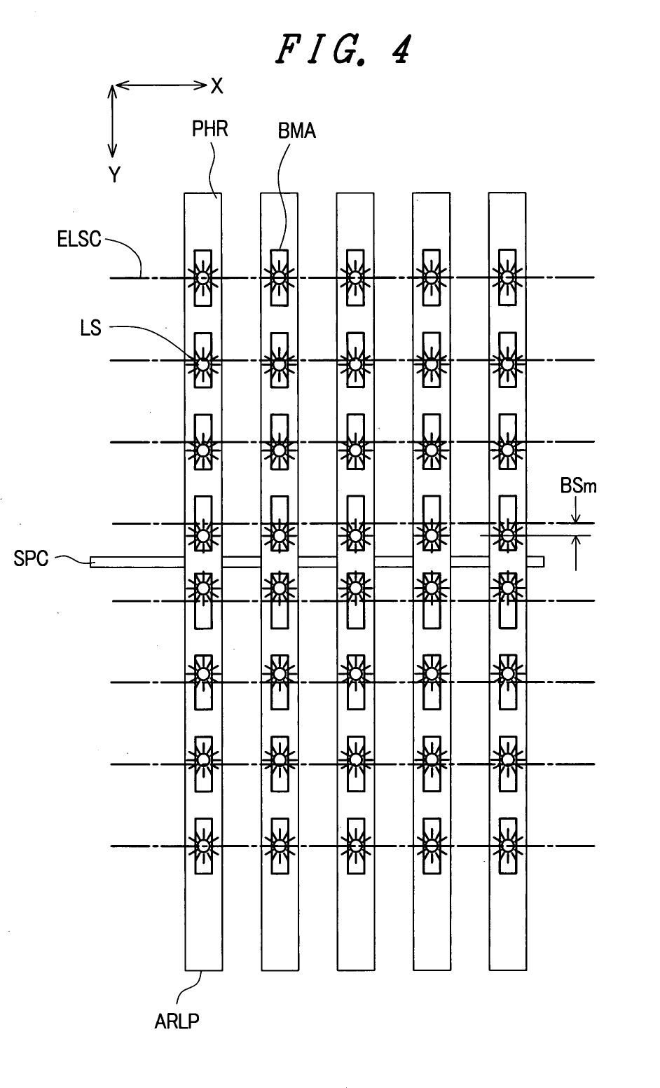

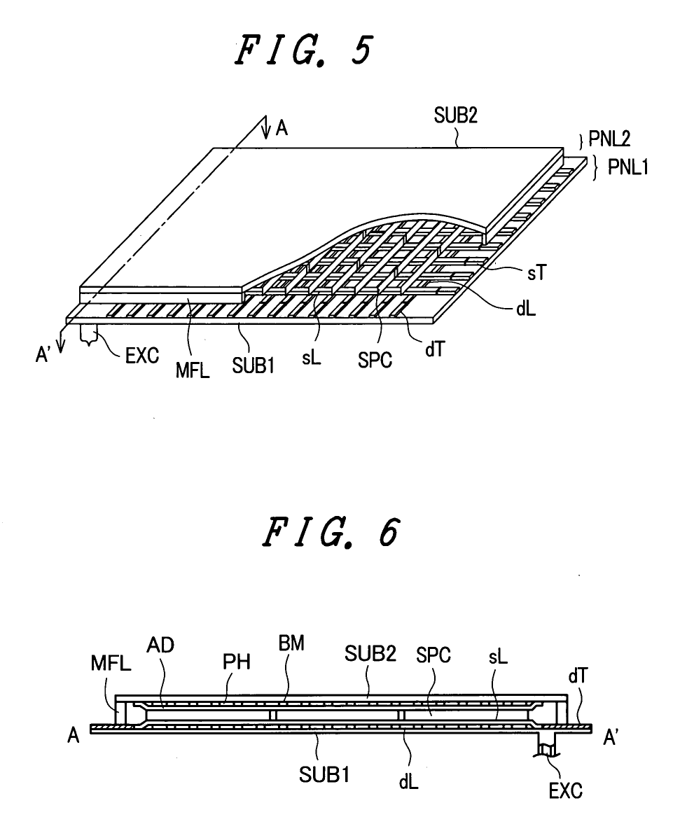

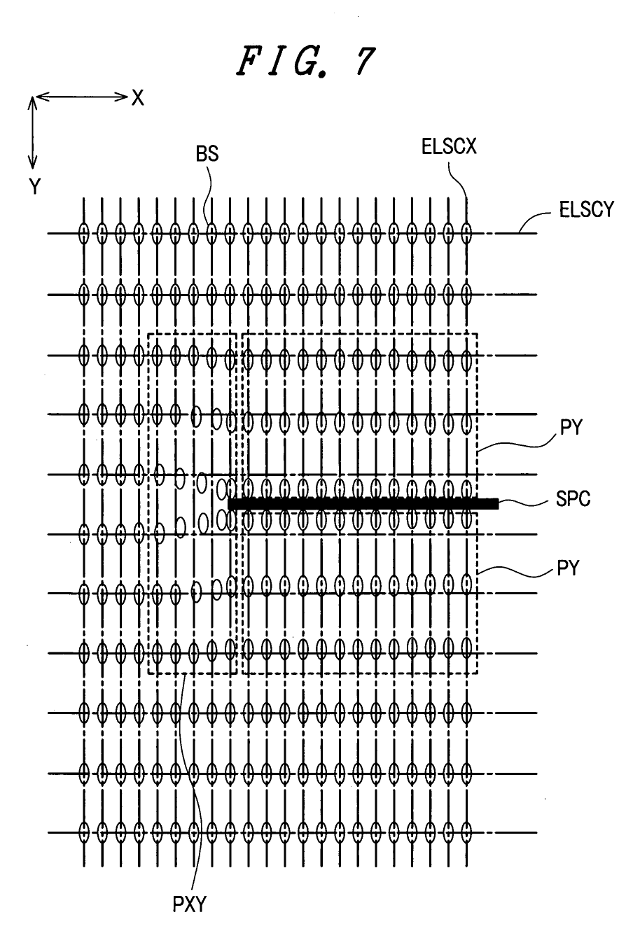

FIG. 4 is a plan view of an essential part for explaining an embodiment 3 of a self-luminous display device according to the present invention. Symbols in FIG. 4 which are equal to the symbols in FIG. 3 correspond to identical parts. The embodiment 3 is characterized by dividing a shape of the black matrix in the embodiment 2 in the vertical direction with a length corresponding to a deviation amount. That is, a shape of a black matrix aperture portion BMA is a divided slot shape which is obtained by dividing in the longitudinal direction (y direction). Here, a height of the black matrix aperture portion BMA is twice or more larger than a maximum beam position deviation BSm in the vicinity of the spacer SPC and, at the same time, is smaller than a dot pitch in the longitudinal direction. By setting the height of the black matrix aperture portion BMA to such a value, even when the electron beams are deviated, the electron beams are radiated to the phosphors and hence, a light emitting quantity of the pixel is not changed thus giving rise to no display defect. Further, compared to the embodiment 2, in the embodiment 3, the aperture area of the phosphor is small and hence, an area of the black matrix is increased whereby the phosphors which do not contribute to the display cannot be observed from a display screen side. Accordingly, a numerical aperture of the phosphor is lowered thus enhancing a contrast in addition to the advantageous effects acquired by the embodiment 2.

According to the present invention, it is unnecessary to lower the resistance of the spacer excessively and hence, the increase of unnecessary power consumption can be prevented thus realizing the acquisition of the low-power display device. Further, since the number of using spacers can be reduced to approximately 20 in a panel of nominal 32 size, the number of parts can be reduced and the number of assembling steps can be reduced, and a cost of spacer parts can be suppressed thus realizing the reduction of cost.

It is needless to say that the present invention is not limited to the display device which uses the MIM elements as the electron sources and is applicable to a display device using electron emission elements of other method such as so-called SED, BSD, HEED or MOS.

What is claimed is:

1. A self-luminous display device comprising:
a back substrate which includes a plurality of data signal lines, a plurality of scanning lines which are arranged to intersect the data signal lines while being insulated from the data signal lines, and a plurality of electron sources which are arranged in the vicinity of intersecting portions of the data signal lines and the scanning lines;
a face substrate which includes a phosphor screen formed of phosphors of a plurality of colors which constitute pairs with the respective electron sources of the back substrate and emit light by being excited by electrons taken out from the electron sources and an anode, the face substrate being arranged to face the back substrate in an opposed manner with a predetermined gap therebetween;
a sealing frame which is inserted between opposing peripheries of the back substrate and the face substrate thus constituting a hermetically sealed space; and
spacers which are arranged in an erected manner in a gap between opposing surfaces of the back substrate and the face substrate while holding the predetermined distance, wherein
the spacer is arranged on the scanning line as a single member having no split portions, and the spacer has both end portions thereof positioned exceeding both sides of a display region formed of a two-dimensional arrangement of the electron sources and the phosphors on the scanning line.

2. A self-luminous display device according to claim 1, wherein the anode is formed to cover the display region with a width thereof exceeding a width of the display region in the extending direction of the scanning lines, and both end portions of the spacer are arranged at positions retracted in the direction toward the display region from the width of the anode.

3. A self-luminous display device according to claim 1, wherein the phosphors are applied to black matrix apertures which are formed in a continuous stripe shape along the extending direction of the data signal lines.

4. A self-luminous display device according to claim 1, wherein the phosphors are applied to the black matrix apertures formed in a divided slot shape which are divided in the extending direction of the data signal line.
